(19) United States
(12) Patent Application Publication
(10) Pub. No.: US 2026/0233533 A1
(43) Pub. Date: Aug. 13, 2026

(54) SYSTEMS AND METHODS FOR REDUCING DROP PLACEMENT ERROR DURING NARROW MEDIA PRINTING ON INKJET SYSTEMS

(71) Applicant: Xerox Corporation, Norwalk, CT (US)

(72) Inventors: Jason M. LeFevre, Penfield, NY (US); Seemit Praharaj, Marlborough, NH (US); Varun Sambhy, Pittsford, NY (US); Douglas K. Herrmann, Webster, NY (US); Anthony S. Condello, Webster, NY (US); Christine A. Steurrys, Williamson, NY (US); Peter M. Gulvin, Webster, NY (US); Mark C. Petropoulos, Webster, NY (US); Nicholas David Stucchi, Greece, NY (US)

(73) Assignee: Xerox Corporation, Norwalk, CT (US)

(21) Appl. No.: 19/051,786

(22) Filed: Feb. 12, 2025

(51) Int. Cl. B41J 2/21; B41J 3/46; B41J 11/00; G06F 3/12; G06K 15/00; G06K 15/02

(52) U.S. Cl. CPC B41J 2/2132; B41J 2/2103; B41J 3/46; B41J 11/008; G06F 3/1208; G06F 3/1254; G06K 15/005; G06K 15/1885; G06K 15/1894; G06K 15/407; G06K 2215/0094; G06K 2215/101

(57) ABSTRACT

Provided herein are inkjet printing systems and methods for preventing inkjet degradation in such inkjet printing systems. The systems and methods described herein may be applied to a number of different types of printing arrangements, but may find particular application in connection with cut-sheet inkjet printing systems where there is continuous narrow-media printing. According to various embodiments, the printing systems include one or more printheads staggered in a cross-process direction and a print engine configured to dynamically adjust the printing orientation of a print job based on the size or other factors associated with a partially printing printhead.

### FIELD OF THE DISCLOSURE

The present disclosure relates generally to inkjet printing systems, and more specifically to systems and methods for reducing ink drop placement error in such inkjet printing systems.

### BACKGROUND

Inkjet printheads, such as piezoelectric printheads, are crucial components of inkjet printing systems and are responsible for transferring ink onto a print media substrate to create text and/or images. These printheads work by ejecting tiny droplets (e.g., on the order of several to tens of picoliters, a picoliter being one trillionth of a liter) through microscopic nozzles, which are arranged in precise arrays. Each nozzle is connected to an ink chamber that holds the ink before ejection. A set of actuators are responsible for creating the pressure pulse that forces the ink out of the nozzles. Piezoelectric actuators are common and employ piezoelectric crystals that change shape when an electric charge is applied, creating a pressure pulse.

In operation, an electric charge is applied to the piezoelectric crystal, causing it to flex and create a pressure pulse. This pulse pushes a droplet of ink out of the nozzle. When the charge is removed, the crystal returns to its original shape, drawing more ink into the chamber. The printhead is controlled by electronic circuits that manage the timing and sequence of droplet ejection to ensure accurate printing.

A single inkjet printing system may contain one or more distinct printheads, and each printhead may contain hundreds or thousands of individual inkjet nozzles arranged in a compact patterned printing array (e.g., within less than a 2 inch by 6 inch area). One or more printheads may be stationary while the print media moves below them, or may move across the print media substrate to deposit ink at specific locations and form the desired print.

While advancements in inkjet printhead technologies have enabled significantly improved image generation and faster printing speeds, there are a number of drawbacks to these printing systems. For example, given the scale of the piezoelectric inkjet printheads and the mechanical and chemical dynamics involved in ejecting tiny droplets of ink, these printheads are susceptible to a number of factors that affect print quality and performance, leading to blurring, banding, or color misalignment. At the nozzle level, these factors can manifest in the drop placement error, i.e., a discrepancy between the intended and actual positions of ink droplets on the substrate.

### SUMMARY OF THE DISCLOSURE

As described herein, it has been found that the internal fluid dynamics of inkjet printhead nozzles is affected by not only whether a particular inkjet has been fired recently, but also by the number and/or position of the neighboring inkjets that have been fired recently. It is appreciated herein that it would be advantageous to provide systems and methods for reducing drop placement error by dynamically utilizing a printhead to mitigate these negative aspects. Embodiments of the present disclosure improve upon these and other aspects in the technology.

According to an embodiment of the present disclosure, an inkjet printing system is provided. The inkjet printing system can include: a media transport system configured to move a print media substrate through a printing zone of the inkjet printing system in a process direction; two or more inkjet printheads disposed above the media transport system, and a print engine. The two or more inkjet printheads can be staggered in a cross-process direction covering a printing width of the printing zone, and each inkjet printhead can include a plurality of inkjets configured to eject ink droplets onto the print media substrate moving through the printing zone. The print engine can include one or more processors and a non-transitory computer-readable storage medium having stored thereon instructions that, when executed by the one or more processors, cause the inkjet printing system to perform the following operations: receive a print job to be completed by the inkjet printing system, wherein the print job comprises print job attributes including a cross-process print job width and an image content, and wherein the cross-process print job width is less than the printing width of the printing zone such that the two or more inkjet printheads comprise a fully printing printhead and a partially printing printhead, the partially printing printhead having a printing region and a non-printing region; determine a first level of inkjet usage in the printing region of the partially printing printhead based on the image content of the print job to be completed; determine a second level of inkjet usage in an outboard region of the fully printing printhead based on the image content of the print job to be completed; and generate a recommended orientation for the print job to be completed based on a comparison of the first level of inkjet usage and the second level of inkjet usage.

In an aspect, the outboard region of the fully printing printhead can have a cross-process width equal to a cross-process width of the printing region of the partially printing printhead.

In an aspect, the print job attributes can further include a default orientation, and the recommended orientation for the print job to be completed can be either the default orientation or a 180° rotation from the default orientation.

In an aspect, the recommended orientation for the print job to be completed can be the default orientation if the second level of inkjet usage in the outboard region of the fully printing printhead is greater than or equal to the first level of inkjet usage in the printing region of the partially printing printhead.

In an aspect, the recommended orientation for the print job to be completed can be the 180° rotation from the default orientation if the second level of inkjet usage in the outboard region of the fully printing printhead is less than to the first level of inkjet usage in the printing region of the partially printing printhead.

In an aspect, the non-transitory computer-readable storage medium of the print engine can further include instructions that, when executed by the one or more processors, cause the inkjet printing system to perform the following operations: automatically set a printing orientation for the print job to be completed based on the recommended orientation generated; and complete the print job based on the set printing orientation.

In an aspect, the first level of inkjet usage can be determined by calculating a total number of inkjet actuations in a first inkjet range required to complete the print job, wherein the first inkjet range corresponds to the printing region of the partially printing printhead. The second level of inkjet usage can be determined by calculating a total number of inkjet actuations in a second inkjet range required to complete the print job, wherein the second inkjet range corresponds to the outboard region of the fully printing printhead.

In an aspect, the first level of inkjet usage can be determined by calculating a total number of inkjets in a first inkjet range that will have at least one actuation while completing the print job, wherein the first inkjet range corresponds to the printing region of the partially printing printhead. The second level of inkjet usage can be determined by calculating a total number of inkjet actuations in a second inkjet range that will have at least one actuation while completing the print job, wherein the second inkjet range corresponds to the outboard region of the fully printing printhead.

In an aspect, the first level of inkjet usage can be determined by calculating a total amount of ink to be jetted through a plurality of inkjets located in a first inkjet range while completing the print job, wherein the first inkjet range corresponding to the printing region of the partially printing printhead. The second level of inkjet usage can be determined by calculating a total amount of ink to be jetted through a plurality of inkjets located in a second inkjet range while completing the print job, wherein the second inkjet range corresponds to the outboard region of the fully printing printhead.

In an aspect, the two or more inkjet printheads can be configured to jet magenta ink.

In an aspect, the inkjet printing system can further include a display device and a user interface, wherein the non-transitory computer-readable storage medium of the print engine further comprises instructions that, when executed by the one or more processors, cause the inkjet printing system to perform the following operations: display, via the display device, the recommended orientation generated for the print job to be completed; receive, via the user interface, user input accepting or rejecting the recommended orientation; and set a printing orientation for the print job to be completed based on the user input received; and complete the print job based on the set printing orientation.

According to another embodiment of the present disclosure, a method for minimizing inkjet degradation in an inkjet printing system is provided. As described, the inkjet printing system can include two or more inkjet printheads staggered in a cross-process direction covering a printing width of a printing zone. The method can include: receiving, by a print engine of the inkjet printing system, a print job to be completed by the inkjet printing system, wherein the print job comprises print job attributes including a cross-process print job width and an image content, wherein the cross-process print job width is less than the printing width of the printing zone such that the two or more inkjet printheads comprise a fully printing printhead and a partially printing printhead, the partially printing printhead having a printing region and a non-printing region; determining a first level of inkjet usage in the printing region of the partially printing printhead based on the image content of the print job to be completed; determining a second level of inkjet usage in an outboard region of the fully printing printhead based on the image content of the print job to be completed; and generating a recommended orientation for the print job to be completed based on a comparison of the first level of inkjet usage and the second level of inkjet usage.

In an aspect, the method can further include: automatically setting a printing orientation for the print job to be completed based on the recommended orientation generated; and completing the print job based on the set printing orientation.

In an aspect, the outboard region of the fully printing printhead can have a cross-process width equal to a cross-process width of the printing region of the partially printing printhead.

In an aspect, the print job attributes can further include a default orientation, and the recommended orientation for the print job to be completed can be either the default orientation or a 180° rotation from the default orientation.

In an aspect, the recommended orientation for the print job to be completed can be the default orientation if the second level of inkjet usage in the outboard region of the fully printing printhead is greater than or equal to the first level of inkjet usage in the printing region of the partially printing printhead, and/or the recommended orientation for the print job to be completed can be the 180° rotation from the default orientation if the second level of inkjet usage in the outboard region of the fully printing printhead is less than to the first level of inkjet usage in the printing region of the partially printing printhead.

In an aspect, the first level of inkjet usage can be determined by calculating a total number of inkjet actuations in a first inkjet range required to complete the print job, wherein the first inkjet range corresponds to the printing region of the partially printing printhead. The second level of inkjet usage can be determined by calculating a total number of inkjet actuations in a second inkjet range required to complete the print job, wherein the second inkjet range corresponds to the outboard region of the fully printing printhead.

In an aspect, the first level of inkjet usage can be determined by calculating a total number of inkjets in a first inkjet range that will have at least one actuation while completing the print job, wherein the first inkjet range corresponds to the printing region of the partially printing printhead. The second level of inkjet usage can be determined by calculating a total number of inkjet actuations in a second inkjet range that will have at least one actuation while completing the print job, wherein the second inkjet range corresponds to the outboard region of the fully printing printhead.

In an aspect, the first level of inkjet usage can be determined by calculating a total amount of ink to be jetted through a plurality of inkjets located in a first inkjet range while completing the print job, wherein the first inkjet range corresponds to the printing region of the partially printing printhead. The second level of inkjet usage can be determined by calculating a total amount of ink to be jetted through a plurality of inkjets located in a second inkjet range while completing the print job, wherein the second inkjet range corresponds to the outboard region of the fully printing printhead.

In an aspect, the method can further include: displaying, on a display device, the recommended orientation generated for the print job to be completed; receiving, via a user interface, user input accepting or rejecting the recommended orientation; setting a printing orientation for the print job to be completed based on the user input received; and completing the print job based on the set printing orientation.

These and other aspects of the various embodiments will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a block diagram of a production inkjet printing system shown in accordance with aspects of the present disclosure.

FIG. 2 is top-down illustration of a print engine and associated media transport system used to form images on print media according to aspects of the present disclosure.

FIG. 3 is a simplified top-down illustration of a print engine and associated media transport system shown in accordance with aspects of the present disclosure.

FIG. 4 is a graph illustrating the impact of partial printing regions in magenta printheads as described in accordance with aspects of the present disclosure.

FIG. 5 is another graph illustrating the impact of partial printing regions in magenta printheads.

FIG. 6 is a flowchart illustrating a method of minimizing inkjet degradation in accordance with aspects of the present disclosure.

FIG. 7 is a block diagram illustrating a printer controller in accordance with aspects of the present disclosure.

### DETAILED DESCRIPTION OF EMBODIMENTS

The present disclosure relates generally to inkjet printing systems, and more specifically to systems and methods for reducing ink drop placement error in such inkjet printing systems. In particular, it has been observed that the print quality of certain inkjet printing systems can become degraded when printing using narrow media under certain conditions due to inkjet clogging and reduced drop placement accuracy.

For example, in some continuous inkjet printing systems, the media transport system may allow for a maximum media width of approximately 14 inches (inboard-to-outboard direction). However, some print jobs will require media that is less than the full 14 inches wide (e.g., 12 inches for a 12″×18″ media is a common size in the print industry). In this narrow media printing scenario, the paper in the printing system is outboard registered (i.e., aligned with the outboard edge of the media transport system), thereby leaving a portion of the inboard printheads which will not be able to jet ink to paper. If the printing system is printing using narrow media for extended periods of time, the unused jets can become degraded and their positional accuracy can become hard to recover. That is, even after switching back to full width printing and performing a conventional jet maintenance routine, the jetting accuracy can be very poor, leading to streaky printing in the previous unused inboard portion of the inboard printhead. In some cases, the common way to resolve this print quality issue is by significant and costly user interventions, such as removing the affected printhead and recirculating it with a solvent, and/or replacing the printhead entirely.

It has also been observed that these print quality issues especially impact the printheads that use magenta ink. Accordingly, the systems and methods of the present disclosure may be applied to a number of different types of inkjet printing systems, but may find particular application in connection with narrow media color printing involving magenta ink printheads.

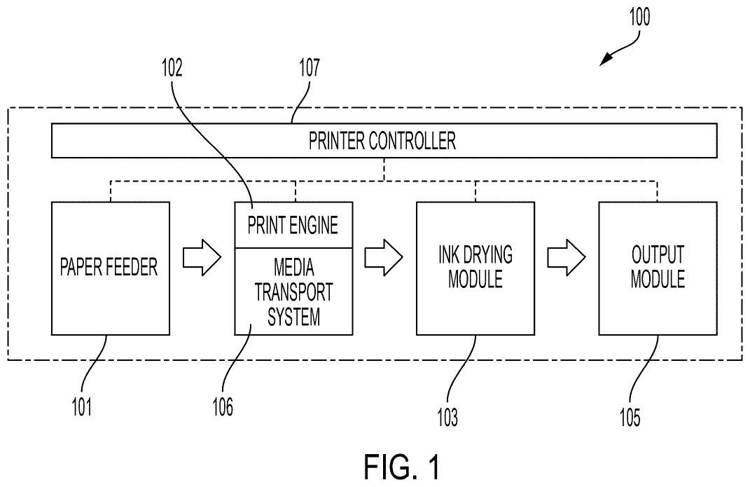

Turning to FIG. 1, a generalized block diagram of a printing system 100 is shown according to aspects of the present disclosure. In embodiments, the inkjet printing system 100 may be a digital printing press, such as a high-performance, cut-sheet inkjet printing system. The printing system 100 may also be a high-volume and high-quality inkjet printing system. In particular embodiments, the printing system 100 may be referred to as a production inkjet (PIJ) system For example and without limitation, the printing system 100 may be a Xerox Baltoro™ HF Inkjet Press, or a similar printing system.

As shown in the example of FIG. 1, the printing system 100 generally includes a cut-sheet paper feeder module 101, a print engine 102, an ink drying module 103, an output module 105, a media transport system 106, and a printer controller 107.

The paper feeder module 101 is configured to store various types of print media and convey the print media to the print engine 102 via the media transport system 106. In embodiments, the paper feeder module 101 can include one or more cassettes or trays and adjustable leveling assemblies configured to move the sheets of print media into proper position when needed for a particular print job. In embodiments, the print media can include, but is not limited to, uncoated plain paper, inkjet treated or inkjet coated paper, offset coated paper, as well as uncoated and/or un-primed paper. In further embodiments, the print media can have different sizes. For example, the feeder module 101 may allow for a maximum media width of approximately 14 inches (inboard-to-outboard direction). However, some print jobs will require media that is less than the full 14 inches wide (e.g., 12 inches for a 12″×18″ media is a common size in the print industry). In this narrow media printing scenario, the paper in the printing system 100 is generally outboard registered (i.e., aligned with the outboard edge of the media transport system 106).

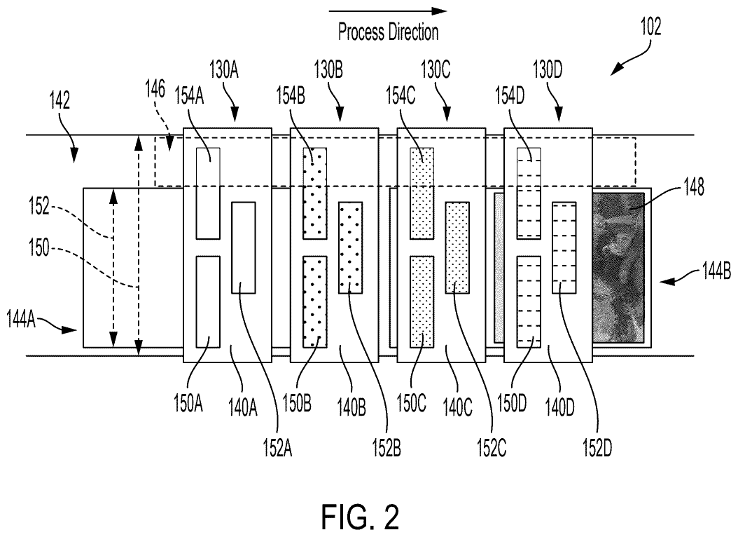

The print engine 102 of the printing system 100 may comprise one or more print bar assemblies, and each print bar assembly may comprise one or more printheads configured to eject ink droplets of a particular color (e.g., magenta, cyan, yellow, and black) within a printing zone. For example, as shown in the example of FIG. 2, the print engine 102 includes four print bar assemblies 130A, 130B, 130C, 130D, wherein each print bar assembly 130A, 130B, 130C, 130D comprises a printhead mounting plate 140A, 140B, 140C, 140D upon which are mounted a total of 12 printheads 150A-D, 152A-D, 154A-D. Each printhead 150A-D, 152A-D, 154A-D may include hundreds to thousands of individually-addressable inkjets, which may be piezoelectric inkjets that can be individually actuated.

In embodiments, the printheads 150A-D, 152A-D, 154A-D of the print engine 102 may be operatively connected to one or more ink reservoirs. In embodiments, the ink reservoirs may be replaceable and/or refillable. In embodiments, each print bar assembly 130A-D may comprise one or more printheads configured to eject ink droplets of a particular color (e.g., magenta, cyan, yellow, and black) within the printing zone. In specific embodiments, the print engine 102 can include four print bar assemblies 130A-D, each having three separate inkjet printheads for a total of 12 printheads. In further embodiments, the inkjet printheads may be piezoelectric printheads having hundreds or thousands of individually-addressable piezoelectric inkjets.

As a print media 144A, 144B moves in a process direction through a printing zone 132 defined by the print bar assemblies 130A, 130B, 130C, 130D, the printheads 150A-D, 152A-D, 154A-D are operated to eject ink droplets in a controlled manner to generate an image on the print media 144A, 144B, like image 148 on print media 144B.

The ink drying module 103 is configured to apply heat and/or pressure to the print media to dry the jetted ink and fuse the jetted ink onto the print media. In embodiments, the ink drying module 103 may be referred to as a fuser. The ink drying module 103 can include, but is not limited to, an array of drying lamps used to dry the ink in a “non-contact” manner.

The output module 105 is configured to present the finished print media for retrieval. In embodiments, the output module 105 can include a stacker that stacks the finished print media.

Optionally, the printing system 100 can also include a finishing module (not shown) that is configured to apply various finishing details to a print job. In embodiments, these finishing details can include, for example, stappling, hole punching, binding, lamination, and/or the like, including combinations thereof.

The media transport system 106 generally includes one or more components configured to convey print media from one or more sources (e.g., feeder module 101) to the print engine 102 and then to an output device 105. In embodiments, the media transport system 106 can include a perforated transport belt 142 disposed on multiple rollers, a vacuum plenum disposed below the transport belt 142, and a vacuum source configured to apply a vacuum through the vacuum plenum and the perforated transport belt 142 in order to keep print media secured to the transport belt 142.

In embodiments, the printing system 100 and the printer controller 107 may be used to implement a printing path schedule based on one or more print orders. The printing system 100 may be capable of continuous printing as well as simplex and/or duplex output. As mentioned above, in cases of narrow media printing, the width 153 of the print media 144A, 144B (and/or the width of the images 148 formed thereon) are consistently less than the full printing width 151 of the printing system 100. In such cases, there are printheads 154A, 154B, 154C, 154D that will consistently have inkjets that go unused for periods of time and therefore are susceptible to degradation. In such embodiments, there will be a non-printing region 146 within the printing zone.

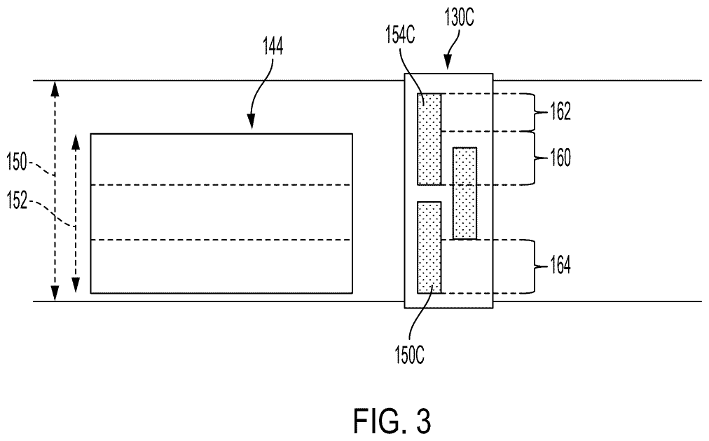

With reference to FIG. 3, further aspects of the printing system 100 are simplified and other aspects are illustrated in more detail. In particular, in accordance with the example of FIG. 3, the printing system 100 can have two or more printheads 150C, 154C staggered in a cross-process direction (i.e., a direction perpendicular to the process section). These printheads 150C, 154C can include at least one printhead 150C that is arranged at an outboard side of the printing system 100, and at least one printhead 154C arranged at an inboard side of the printing system 100. As shown, the edge of the media 144 is typically aligned with the outboard side of the printing system 100. As such, when printing on narrow media 144 such that the cross-process print job width 153 is less than the full printing width 151 of the printing system 100, there will be a portion of the inboard printhead 154C that is used to jet ink onto the print media 144 and a portion of the inboard printhead 154C that is not used to jet ink onto the print media 144. Put another way, while the inkjets located in the printing region 160 of the printhead 154C may be used, there will be a non-printing region 162 were a plurality of inkjets go unused for a period of time.

As also shown in FIG. 3, the fully printing printhead 150C will have an outboard printing region 164 that covers a cross-process width at least as large as the cross-process width of the printing region 160 of the partially printing printhead 154C. When left unaddressed, this arrangement of narrow-media printing will result in significant and potentially irreversible degradation of inkjet printing performance, which ultimately requires printhead replacement and causes unnecessary waste.

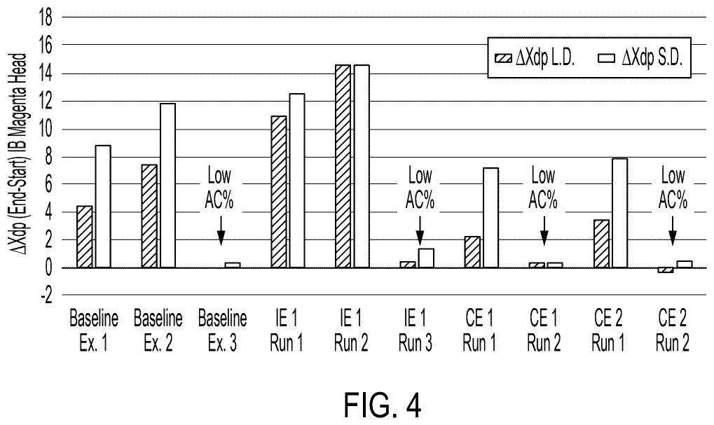

For example, with reference to FIG. 4, the negative effects that the partially printing printhead exhibit are illustrated in accordance with several test print jobs that were conducted. In particular, several test cases were run where two 10 Kp runs on 12″×18″ SEF paper were run, in which a first case used Mid/High AC % print volume mix and the second case used Low AC % image (“chip-out”). At the beginning and end of each test, a purge-wide-analyze routine was performed, and the drop placement error (Xdp) of the inboard printhead (e.g., printhead 154C) was recorded. The difference between these two Xdp values (end-start) is a measure of the overall jetting degradation (where zero is no degradation, and a higher number indicates worsening degradation).

As shown, a higher level of jetting degradation (ΔXdp) in the “non-printing” areas of the “partially printing” printheads is noted when the standard 10 Kp (10,000 prints) of mid/high AC % (magenta pixel usage in particular) run is made. In these runs, magenta pixels are being fired from the “printing area” of the “partially-printing” printheads at a significant rate. In contrast, the runs labelled “Low AC %” (i.e., chip-out), magenta pixel usage in the “rinting area” of the “partially-printing” printhead is very low. In those cases, it is seen that the jetting degradation (ΔXdp) is much smaller. This consistent outcome demonstrates the effects of pixel usage (especially in magenta ink) that the “printing area” can have on the “non-printing” area of the “partially-printing” printhead.

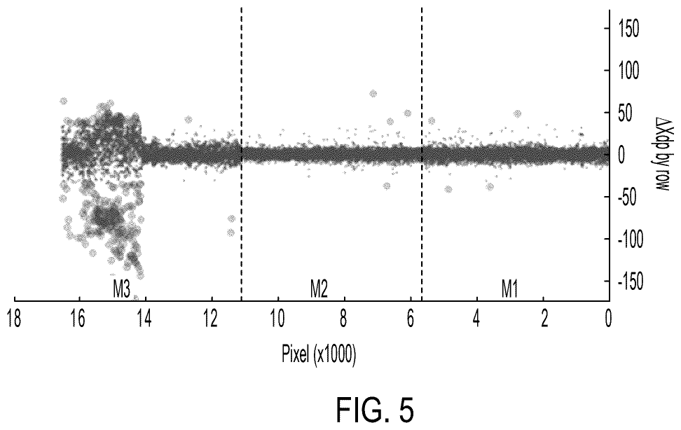

With reference to FIG. 5, this effect on drop placement error is shown on an individual jet-by-jet basis at the end of a run using Mid/High AC % in the printing region 160 of the partially printing printhead 154C with a 12″ wide print media 144. As shown, the inboard magenta printhead (M3) 154C with the very left half of the printhead which is in the non-printing region 162 experienced very severe Xdp degradation over the run, even after a purge routine has been performed. In contrast, the right half of the printhead experiences no Xdp degradation since it is in the printing region 160.

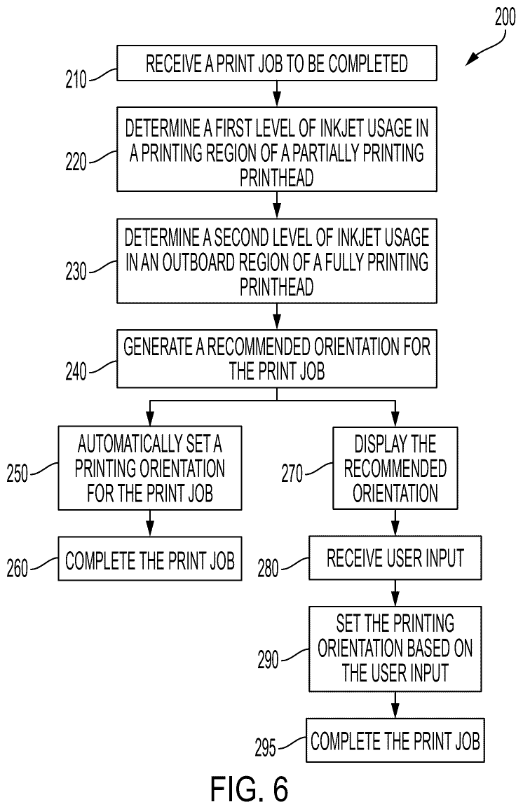

To address these and other issues, the printing systems 100 of the present disclosure are configured to perform a method for minimizing inkjet degradation. For example, with reference to FIG. 6, one such method 200 is illustrated in accordance with certain aspects of the present disclosure. As shown, the method 200 can include: in a step 210, receiving a print job to be completed by an inkjet printing system 100; in a step 220, determining a first level of inkjet usage in a printing region of a partially printing printhead based on the image content of the print job to be completed; in a step 230, determining a second level of inkjet usage in an outboard region of a fully printing printhead based on the image content of the print job to be completed; and in a step 240, determining a recommendation as to whether the orientation for the print job to be completed should adjusted based on the first and second levels of inkjet usage. In some embodiments, the method 200 can also include: in a step 250, automatically setting a printing orientation for the print job to be completed; and in a step 260, completing the print job based on the set printing orientation. In further embodiments, the method 200 can include: in a step 270, displaying the recommended orientation generated for the print job to be completed; in a step 280, receiving user input accepting or rejecting the recommended orientation; in a step 290, setting the printing orientation for the print job to be completed based on the user input received; and in a step 295, completing the print job based on the set printing orientation.

As described herein, the printing system 100 can include at least two or more inkjet printheads 150C, 154C staggered in a cross-process direction covering a printing width 151 of the printing system 100, as described above. However, it should be appreciated that the printing system 100 may include one or more additional printheads, such as printhead 152C. Furthermore, it should be appreciated that each of these printheads 150C, 152C, 154C may be configured to jet the same type (i.e., color) of ink, including but not limited to magenta ink.

In the step 210, the method 200 can include receiving, at the printer controller 107 of the printing system 100, a print job to be completed by the printing system 100. In embodiments, the print job can include a digital file containing image content to be recreated on the print media 144. For example, the digital file can be in the form of a DOCX, EXLX, JPEG, PNG, PDF, or other file formats, including combinations thereof. The print job can include a number of print job attributes associated with the print job, such as the specifications for the print media to be used, the specifications for the ink and print quality, metadata associated with the print job, the image content (i.e., the pictures or text to be recreated), and/or the like.

In particular embodiments, the print job attributes include at least a cross-process print job width. In specific embodiments, the cross-process print job width can be the print job width 153 shown in FIG. 3, which represents the width of the print media 144 to be printed on. In certain embodiments, the cross-process print job width can be the cross-process width corresponding to the size of the image content to be recreated on the print media 144, which may be less than the full cross-process width 153.

As described herein, the cross-process print job width may be less than the full printing width 151 of the printing system 100. As such, one of the two or more printheads 150C, 154C will be a fully printing printhead 150C where all inkjets are in range to be used when completing the print job, as well as a partially printing printhead 154C where at least some of the inkjets are out of range of the print media/image content to be recreated.

Next, in the steps 220 and 230, the method 200 can include determining a first and second level of inkjet usage in a particular region associated with each of the two or more printheads 150C, 154C.

Initially, it should be understood that the printer controller 107 of the printing system 100 will have stored knowledge regarding the layout and availability of each inkjet within each printhead 150C, 152C, 154C of the printing system 100, which is necessary to calculate the how much ink of each color (e.g., CMYK) and the exact position to place each ink droplet based on the image content. That is, the printer controller 107 will contain hardware and software necessary to convert the image content of a print job into instructions for actuating the inkjets of the printheads (i.e., converting the image content into a bitmap, separating the pixels of the bitmap into its primary color components, rasterizing the bitmap, calculating the size and placement of each ink droplet to recreate each pixel, and operate the inkjets of multiple printheads to eject the desired combination of ink droplets).

Accordingly, in particular embodiments, the step 220 includes first defining a printing region 160 and a non-printing region 162 of the partially printing printhead 154C. The printing region 160 may be defined as a subset of one or more inkjets on the printhead 154C that will be used when completing the print job. Similarly, after the printing region 160 of the partially printing printhead 154C is defined, an outboard region 164 of the fully printing printhead 150C may be defined based on the size of the printing region 160.

In particular embodiments, the step 230 can first include defining an outboard printing region 164 of the fully printing printhead 150C that has a cross-process width equal to the cross-process width of the printing region 160. The outboard printing region 164 may therefore be defined as a subset of one or more inkjets on the printhead 150C that will be used when completing the print job.

Once the printing region 160 of the partially printing printhead 154C is defined, the step 220 can include determining a first level of inkjet usage corresponding to this region 160 based on the image content of the print job to be completed. Similarly, once the outboard printing region 164 of the fully printing printhead 150C is defined, the step 230 can include determining a second level of inkjet usage corresponding to this region 164 based on the image content of the print job to be completed.

According to aspects of the present disclosure, the first and second levels of inkjet usage corresponding to a particular region of the printheads 150C, 154C may be quantified in several ways.

In one embodiment, the first level of inkjet usage may be determined by calculating a total number of inkjet actuations by the subset of inkjets corresponding to the printing region 160 of the printhead 154C, and the second level of inkjet usage may be determined by calculating a total number of inkjet actuations by the subset of inkjets corresponding to the outboard region 164 of the printhead 150C. For example, each printhead 150C, 154C may have approximately 5500 inkjets, and the printing regions 160, 164 correspond to inkjets numbers 1 to 2000 of each respective printhead 150C, 154. The printer controller 107 may then calculate, for the entire print job, the number of times the inkjets 1 to 2000 of the printhead 154C are actuated to determine the first level of inkjet usage, and calculate the number of times the inkjets 1 to 2000 of the printhead 150C are actuated to determine the second level of inkjet usage.

In another embodiment, the first level of inkjet usage may be determined by calculating the total number of inkjets within the printing region 160 of the printhead 154C that will be actuated at least once while completing the print job, and the second level of inkjet usage may be determined by calculating the total number of inkjets within the printing region 164 of the printhead 150C that will be actuated at least once while completing the print job. For example, the printing region 160 may cover inkjets 1 to 2000 of the printhead 154C, but only a subset of those inkjets may be used. Similarly, the outboard region 164 may cover inkjets 1 to 2000 of the printhead 150C, but only a subset of those inkjets may be used. In some embodiments, instead of counting the number of inkjets that are actuated at least one, the level of inkjet usage may count the number of inkjets that are actuated at least a threshold number of times, e.g., at least 10 times, at least 100 times, at least 500 times, etc. In embodiments, this threshold may be a rate (i.e., a number of actuations per minute while completing the print job).

In further embodiments, the first level of inkjet usage may be determined by calculating the total amount of ink to be jetted through a plurality of inkjets located in the printing region 160 of the printhead 154C, and the second level of inkjet usage may be determined by calculating the total amount of ink to be jetted through a plurality of inkjets located in the outboard region 164 of the printhead 150C. For example, the printing region 160 may cover inkjets 1 to 2000 of the printhead 154C and the outboard region 164 may cover inkjets 1 to 2000 of the printhead 150C, but the total amount of ink jetted through inkjets 1 to 2000 of the printhead 154C may be different than the total amount of ink jetted through inkjets 1 to 2000 of the printhead 150C, e.g., depending on the image content. Accordingly, the first and second levels of inkjet usage may be dependent on the amount of ink jetted through the inkjets corresponding to the respective regions 160, 164 rather than the number of inkjets used or the extent of the number of individual actuations.

Once the first and second levels of inkjet usage have been determined, the method 200 can then include, in a step 240, generating a recommendation as to whether the orientation for the print job to be completed should adjusted based on the first and second levels of inkjet usage. As described herein, the print job attributes for each print job may have a default orientation representing how the image content will be reproduced on the print media 144. In general, the default orientation may be referred to as 0°.

In embodiments, the recommended orientation for the print job to be completed can be determined by comparing the first and second levels of inkjet usage. If the second level of inkjet usage is greater than or equal to the first level of inkjet usage, then the printer controller 107 can recommend that the print job be completed in the default orientation. However, if the second level of inkjet usage is less than the first level of inkjet usage, then the printer controller 107 can recommend that the print job be completed in a different orientation in order to minimize the inkjet usage in the printing region 160 of the partially printing printhead 154C. For example, in such embodiments, the recommended orientation may be 180°, i.e., a 180° rotation from the default orientation. In this way, the printing system 100 can dynamically adjust the printing orientation of the print job in order to preserve inkjet health.

In the step 250, the method 200 can include automatically setting the printing orientation for the print job to be the recommended orientation. In embodiments, this may include leaving the printing orientation as the default orientation. In other embodiments, the printing orientation may be 180°. Then, in the step 260, the method 200 can include completing the print job in accordance with the printing orientation that was automatically set.

Additionally and/or alternatively, the method 200 can include one or more of the following: in a step 270, displaying the recommended orientation; in a step 280, receiving user input related to the recommended orientation; in a step 290, setting the printing orientation based on the user input; and in a step 295, completing the print job.

More specifically, in embodiments, the step 270 can include displaying the recommended orientation to a user via a display device (described in more detail below). The display device may be part of the printing system 100, but it is also contemplated that the display device in communication with the printing system 100 but is separate (i.e., not integrated) therefrom.

In the step 280, the method 200 can also include receiving user input related to the recommended orientation, including user input that accepts or approves the recommended orientation or user input that rejects or denies the recommended orientation. The user input may be received via a user interface (described in more detail below). However, like the display device, the user interface may be part of the printing system 100 or may be in communication with the printing system 100 but provided separately therefrom.

In the step 290, the method 200 can then include setting the printing orientation of the print job in accordance with the user input received. For example, if the user input accepts/approves the recommended orientation, then the recommended orientation will be set as the printing orientation. If the user input rejects/denies the recommended orientation, then the default orientation will be used as the printing orientation. However, it is also contemplated that steps 270, 280, 290 only if the recommended orientation is different from the default orientation.

In the step 295, the printing system 100 will then complete the print job in accordance with the user input received.

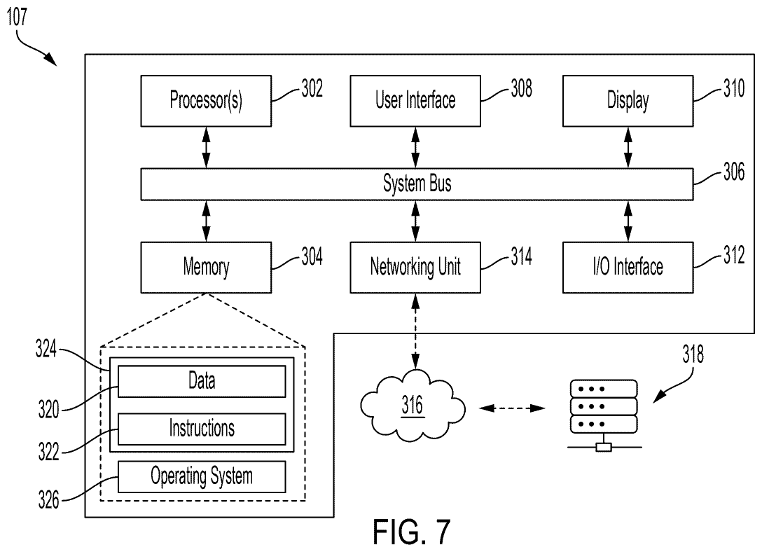

Turning to FIG. 7, the printing systems 100 of the present disclosure may include a printer controller 107 configured to perform one or more processes of the methods described herein. More specifically, the memory 304 can be configured to store data/information 320 and computer-readable instructions 322 that, when executed by one or more processors 302, causes the printing system 100 to perform a method of minimizing inkjet degradation as described above.

In embodiments, the printer controller 107 can include one or more processors 302 and a computer-readable memory 304 interconnected and/or in communication via a system bus 306 containing conductive circuit pathways through which instructions (e.g., machine-readable signals) may travel to effectuate communication, tasks, storage, and the like. The printer controller 107 can be connected to a power source (not shown), which can include an internal power supply and/or an external power supply. In embodiments, the printer controller 107 can also include one or more additional components, such as a user interface 308, a display 310, an input/output (I/O) interface 312, a networking unit 314, and the like, including combinations thereof. As shown, each of these components may be interconnected and/or in communication via the system bus 306, for example.

In embodiments, the one or more processors 302 can include one or more high-speed data processors adequate to execute the program components described herein and/or perform one or more operations of the methods described herein. The one or more processors 302 may include a microprocessor, a multi-core processor, a multithreaded processor, an ultra-low voltage processor, an embedded processor, and/or the like, including combinations thereof. The one or more processors 302 can include multiple processor cores on a single die and/or may be a part of a system on a chip (SoC) in which the processor 302 and other components are formed into a single integrated circuit, or a single package. That is, the one or more processors 302 may be a single processor, multiple independent processors, or multiple processor cores on a single die.

In embodiments, the user interface 308 may be configured to receive various forms of input from a user associated with the printing system 100. The user interface 308 can include, but is not limited to, one or more of a keyboard, keypad, trackpad, trackball(s), capacitive keyboard, controller (e.g., a gaming controller), computer mouse, computer stylus/pen, a voice input device, and/or the like, including combinations thereof.

In embodiments, the display device 310 may be configured to display information, including text, graphs, and/or the like. In particular embodiments, the display device 310 may be configured to display device-generated recommendations, such as recommended orientations for various print jobs. The display device 310 can include, but is not limited to, a liquid crystal display (LCD), a light-emitting diode (LED) display, a touch screen or other touch-enabled display, a foldable display, a projection display, and so on, or combinations thereof.

In embodiments, the input/output (I/O) interface 312 may be configured to connect and/or enable communication with one or more peripheral devices (not shown), including but not limited to additional machine-readable memory devices, diagnostic equipment, and other attachable devices. The I/O interface 312 may include one or more I/O ports that provide a physical connection to the one or more peripheral devices. In some embodiments, the I/O interface 312 may include one or more serial ports.

In embodiments, the networking unit 314 may include one or more types of networking interfaces that facilitate wired and/or wireless communication between the printer controller 107 and one or more external devices. That is, the networking unit 314 may operatively connect the printer controller 107 to one or more types of communications networks 316, which can include a direction interconnection, the Internet, a local area network (“LAN”), a metropolitan area network (“MAN”), a wide area network (“WAN”), a wired or Ethernet connection, a wireless connection, a cellular network, Bluetooth®, and similar types of communications networks, including combinations thereof. In some embodiments, the printer controller 107 may communicate with one or more remote/cloud-based servers and/or cloud-based services, such as remote server 318, via the communications network 316.

In embodiments, the memory 304 can be variously embodied in one or more forms of machine accessible and machine-readable memory. In some embodiments, the memory 304 can be a storage device, which can include, but is not limited to, a non-transitory storage medium, a magnetic disk storage, an optical disk storage, an array of storage devices, a solid-state memory device, and/or the like, as well as combinations thereof. The memory 304 may also include one or more other types of memory, such as dynamic random-access memory (DRAM), static random-access memory (SRAM), erasable programmable read-only memory (EPROM), electrically erasable programmable read-only memory (EEPROM), Flash memory, and/or the like, as well as combinations thereof. In embodiments, the memory 304 may include one or more types of transitory and/or non-transitory memory.

In embodiments, the data 320 and the computer-readable instructions 322 stored in the memory 304 may form an inkjet preservation package 324 that may be incorporated into, loaded from, loaded onto, or otherwise operatively available to and from the printing system 100. Thus, in some embodiments, the inkjet preservation package 324 and/or one or more individual software packages may be stored in a local storage device of the memory 304. However, in other embodiments, the inkjet preservation package 324 and/or one or more individual software packages may be loaded onto and/or updated from a remote server or service, such as server 318, via the communications network 316.

The printer controller 107 may also include an operating system component 326, which may be stored in the memory 304. The operating system component 326 may be an executable program facilitating the operation of the printing system 100. Typically, the operating system component 326 can facilitate access of the I/O interface 312, network interface 314, the user interface 308, and the display 310, and can communicate or control other components of the printing system 100.

Accordingly, provided herein is a computer program product 324 comprising a non-transitory computer-readable storage medium 304 having stored thereon computer-readable instructions 322 that, when executed by one or more processors (such as processors 302), cause the one or more processors to perform one or more operations of the methods described above.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. An inkjet printing system comprising:
a media transport system configured to move a print media substrate through a printing zone of the inkjet printing system in a process direction;
two or more inkjet printheads disposed above the media transport system, wherein the two or more inkjet printheads are staggered in a cross-process direction covering a printing width of the printing zone, and wherein each inkjet printhead comprises a plurality of inkjets configured to eject ink droplets onto the print media substrate moving through the printing zone;
a print engine comprising one or more processors and a non-transitory computer-readable storage medium having stored thereon instructions that, when executed by the one or more processors, cause the inkjet printing system to perform the following operations:
receive a print job to be completed by the inkjet printing system, wherein the print job comprises print job attributes including a cross-process print job width and an image content, and wherein the cross-process print job width is less than the printing width of the printing zone such that the two or more inkjet printheads comprise a fully printing printhead and a partially printing printhead, the partially printing printhead having a printing region and a non-printing region;
determine a first level of inkjet usage in the printing region of the partially printing printhead based on the image content of the print job to be completed;
determine a second level of inkjet usage in an outboard region of the fully printing printhead based on the image content of the print job to be completed; and
generate a recommended orientation for the print job to be completed based on a comparison of the first level of inkjet usage and the second level of inkjet usage.

2. The inkjet printing system of claim 1, wherein the outboard region of the fully printing printhead has a cross-process width equal to a cross-process width of the printing region of the partially printing printhead.

3. The inkjet printing system of claim 1, wherein the print job attributes further include a default orientation, and the recommended orientation for the print job to be completed is either the default orientation or a 180° rotation from the default orientation.

4. The inkjet printing system of claim 3, wherein the recommended orientation for the print job to be completed is the default orientation if the second level of inkjet usage in the outboard region of the fully printing printhead is greater than or equal to the first level of inkjet usage in the printing region of the partially printing printhead.

5. The inkjet printing system of claim 3, wherein the recommended orientation for the print job to be completed is the 180° rotation from the default orientation if the second level of inkjet usage in the outboard region of the fully printing printhead is less than to the first level of inkjet usage in the printing region of the partially printing printhead.

6. The inkjet printing system of claim 3, wherein the non-transitory computer-readable storage medium of the print engine further comprises instructions that, when executed by the one or more processors, cause the inkjet printing system to perform the following operations:
automatically set a printing orientation for the print job to be completed based on the recommended orientation generated; and
complete the print job based on the set printing orientation.

7. The inkjet printing system of claim 1, wherein the first level of inkjet usage is determined by calculating a total number of inkjet actuations in a first inkjet range required to complete the print job, the first inkjet range corresponding to the printing region of the partially printing printhead, and
wherein the second level of inkjet usage is determined by calculating a total number of inkjet actuations in a second inkjet range required to complete the print job, the second inkjet range corresponding to the outboard region of the fully printing printhead.

8. The inkjet printing system of claim 1, wherein the first level of inkjet usage is determined by calculating a total number of inkjets in a first inkjet range that will have at least one actuation while completing the print job, the first inkjet range corresponding to the printing region of the partially printing printhead, and
wherein the second level of inkjet usage is determined by calculating a total number of inkjet actuations in a second inkjet range that will have at least one actuation while completing the print job, the second inkjet range corresponding to the outboard region of the fully printing printhead.

9. The inkjet printing system of claim 1, wherein the first level of inkjet usage is determined by calculating a total amount of ink to be jetted through a plurality of inkjets located in a first inkjet range while completing the print job, the first inkjet range corresponding to the printing region of the partially printing printhead, and
wherein the second level of inkjet usage is determined by calculating a total amount of ink to be jetted through a plurality of inkjets located in a second inkjet range while completing the print job, the second inkjet range corresponding to the outboard region of the fully printing printhead.

10. The inkjet printing system of claim 1, wherein the two or more inkjet printheads are configured to jet magenta ink.

11. The inkjet printing system of claim 1, further comprising a display device and a user interface, wherein the non-transitory computer-readable storage medium of the print engine further comprises instructions that, when executed by the one or more processors, cause the inkjet printing system to perform the following operations:
display, via the display device, the recommended orientation generated for the print job to be completed;
receive, via the user interface, user input accepting or rejecting the recommended orientation; and
set a printing orientation for the print job to be completed based on the user input received; and complete the print job based on the set printing orientation.

12. A method for minimizing inkjet degradation in an inkjet printing system comprising two or more inkjet printheads staggered in a cross-process direction covering a printing width of a printing zone, the method comprising:
receiving, by a print engine of the inkjet printing system, a print job to be completed by the inkjet printing system, wherein the print job comprises print job attributes including a cross-process print job width and an image content, wherein the cross-process print job width is less than the printing width of the printing zone such that the two or more inkjet printheads comprise a fully printing printhead and a partially printing printhead, the partially printing printhead having a printing region and a non-printing region;
determining a first level of inkjet usage in the printing region of the partially printing printhead based on the image content of the print job to be completed;
determining a second level of inkjet usage in an outboard region of the fully printing printhead based on the image content of the print job to be completed; and
generating a recommended orientation for the print job to be completed based on a comparison of the first level of inkjet usage and the second level of inkjet usage.

13. The method of claim 12, further comprising:
automatically setting a printing orientation for the print job to be completed based on the recommended orientation generated; and
completing the print job based on the set printing orientation.

14. The method of claim 12, wherein the outboard region of the fully printing printhead has a cross-process width equal to a cross-process width of the printing region of the partially printing printhead.

15. The method of claim 12, wherein the print job attributes further include a default orientation, and the recommended orientation for the print job to be completed is either the default orientation or a 180° rotation from the default orientation.

16. The method of claim 15, wherein the recommended orientation for the print job to be completed is the default orientation if the second level of inkjet usage in the outboard region of the fully printing printhead is greater than or equal to the first level of inkjet usage in the printing region of the partially printing printhead, and/or
wherein the recommended orientation for the print job to be completed is the 180° rotation from the default orientation if the second level of inkjet usage in the outboard region of the fully printing printhead is less than to the first level of inkjet usage in the printing region of the partially printing printhead.

17. The method of claim 12, wherein the first level of inkjet usage is determined by calculating a total number of inkjet actuations in a first inkjet range required to complete the print job, the first inkjet range corresponding to the printing region of the partially printing printhead, and
wherein the second level of inkjet usage is determined by calculating a total number of inkjet actuations in a second inkjet range required to complete the print job, the second inkjet range corresponding to the outboard region of the fully printing printhead.

18. The method of claim 12, wherein the first level of inkjet usage is determined by calculating a total number of inkjets in a first inkjet range that will have at least one actuation while completing the print job, the first inkjet range corresponding to the printing region of the partially printing printhead, and
wherein the second level of inkjet usage is determined by calculating a total number of inkjet actuations in a second inkjet range that will have at least one actuation while completing the print job, the second inkjet range corresponding to the outboard region of the fully printing printhead.

19. The method of claim 12, wherein the first level of inkjet usage is determined by calculating a total amount of ink to be jetted through a plurality of inkjets located in a first inkjet range while completing the print job, the first inkjet range corresponding to the printing region of the partially printing printhead, and
wherein the second level of inkjet usage is determined by calculating a total amount of ink to be jetted through a plurality of inkjets located in a second inkjet range while completing the print job, the second inkjet range corresponding to the outboard region of the fully printing printhead.

20. The method of claim 12, further comprising:
displaying, on a display device, the recommended orientation generated for the print job to be completed;
receiving, via a user interface, user input accepting or rejecting the recommended orientation;
setting a printing orientation for the print job to be completed based on the user input received; and
completing the print job based on the set printing orientation.
